(19) United States
(12) Patent Application Publication
(10) Pub. No.: US 2013/0167006 A1
(43) Pub. Date: Jun. 27, 2013

(54) WIKI-BASED INFORMATION PROVISION SYSTEM AND INFORMATION RETRIEVAL METHOD USING RELATIONSHIPS BETWEEN USERS

(71) Applicants: Hyun Kyung YOO, Daejeon (KR); Hyun Joo BAE, Daejeon (KR); Young Mee SHIN, Daejeon (KR)

(72) Inventors: Hyun Kyung YOO, Daejeon (KR); Hyun Joo BAE, Daejeon (KR); Young Mee SHIN, Daejeon (KR)

(73) Assignee: Electronics and Telecommunications Research Institute, Daejeon (KR)

(21) Appl. No.: 13/612,056

(22) Filed: Sep. 12, 2012

(30) Foreign Application Priority Data
Dec. 27, 2011 (KR) 10-2011-0143850

(51) Int. Cl. G06F 17/00; G06F 17/30

(52) U.S. Cl. 715/234

(57) ABSTRACT

Disclosed are a system and method for sharing and retrieving information through a Wiki technology. A Wiki-based information provision system according to the present invention includes a Wiki information input unit for receiving, from a user, a command for writing or changing Wiki information defining a web page written and shared by users included in a group consisting of a plurality of users; and a Wiki server for managing the Wiki information input by the user by using information about associative relationship between the users according to classes or interests of the users. The system according to the present invention may filter a retrieval result using associative relationship between users and first provide information written by a user of the same group as the retrieval result, thus establishing an efficient knowledge collaboration structure.

### CROSS-REFERENCE TO RELATED APPLICATIONS

This application claims priority to and the benefit of Korean Patent Application No. 10-2011-0143850 filed in the Korean Intellectual Property Office on Dec. 27, 2011, the entire contents of which are incorporated herein by reference.

### TECHNICAL FIELD

The present invention relates to a Wiki technology for providing a knowledge collaboration function by utilizing social network information of company members. The Wiki technology provides retrieval results according to whether the knowledge is written by members in the same group, by allowing the company members to create and share the knowledge on-line via a Wiki with personal computers or smart phones and filtering the knowledge in consideration of a work organization of the members and social relationships of communities when retrieving the shared knowledge.

### BACKGROUND ART

Enterprise 2.0 is a technology where Web 2.0 technology based on participation and sharing is applied for enterprises, and aims to create and share knowledge through the participation of members, thus effectively determining group intention of the members with collaboration from the members and enhancing work efficiency. In Enterprise 2.0, as users are not only consumers using information, but also information providers creating new information, collaboration is emphasized to utilize collective intelligence through participation of users to find and share desired information or knowledge whenever necessary. The range of collaboration expands on-line, thereby enabling document management and group work irrespective of time and place.

Enterprise 2.0 utilizes various social media such as Wiki, blogs, and social bookmarks as well as basic communication tools such as a telephone, conference, e-mail, and instant messaging, for effective communication between enterprise members.

In the blog, an information publisher registers information and then states his/her opinion in which community members may register comments in response to his/her opinion. The information publisher can easily change the information. The members cannot modify the information registered by the information publisher, but just can add opinions. As the social bookmark, a user can bookmark a useful page of the corresponding webpage, and other users can make the bookmark in personal area, thereby evaluating serviceability of the specific page depending on the number of persons who bookmark the page.

The Wiki is a readable and writable website. The users can easily use and set the webpage and also create and change the page. A version history is kept for each page in the Wiki. Accordingly, contribution of each user can be identified and the created knowledge can be evaluated with comment on or preference for the knowledge. The knowledge stored through the Wiki is retrieved on the basis of tags, which correspond to respective keywords of the corresponding pages, and thus the retrieved result is provided.

Representative communication tools typically used by enterprises are a telephone, conference, e-mail, and the like, which have temporal and spatial limitations. In the related art, when information stored through the Wiki is retrieved, a simple keyword based retrieval result is provided, thereby having a disadvantage of not reflecting social relationships of users.

### SUMMARY OF THE INVENTION

The present invention has been made in an effort to provide a system for providing Wiki information filtered using associative relationships between users requesting the Wiki information when providing the Wiki information.

The present invention also has been made in an effort to filter and provide retrieval result on the basis of a class organization and a social relationship of a user, thus enabling knowledge collaboration of finding and sharing appropriate information on the basis of a social network of a member.

An exemplary embodiment of the present invention provides a Wiki-based information provision system including: a Wiki information input unit for receiving, from a user, a command for writing or changing Wiki information defining a web page written and shared by users included in a group consisting of a plurality of users; and a Wiki server for managing the Wiki information input by the user by using information about associative relationship between the users according to classes or interests of the users.

The Wiki server may include: a user information management unit for managing the information about associative relationship between the users; a Wiki information management unit for managing the Wiki information; and a search unit for retrieving the Wiki information managed by the Wiki information management unit, filtering the retrieved information with the information about associative relationship between the users, and providing the filtered information.

The Wiki-based information provision system may further include an authority management unit for controlling access authorities of the users for sharing the Wiki information.

The Wiki information management unit may include: a page management unit for managing change in pages forming the Wiki information; a version management unit for managing a version defining information about the change in pages; and a page tag management unit for managing a tag corresponding to a keyword signifying characteristics of each page.

The user information management unit may manage associative relationship expanded on the basis of a first relationship defining a class associative relationship between the users included in the group and a second relationship defining an interest associative relationship between the users.

The search unit may retrieve the Wiki information using the tag of the page tag management unit and filters the retrieved Wiki information using the expanded associative relationship.

The search unit may first provide the user with the Wiki information written by the user corresponding to the expanded associative relationship when providing the filtered Wiki information.

The Wiki-based information provision system may further include a database for storing the Wiki information written by the user, and the Wiki information management unit of the Wiki server may manage the Wiki information in linkage with the database.

The database may store the Wiki information in a data file or database form using a structured query language (SQL) for database access.

The Wiki-based information provision system may further include: a directory server for managing information about a class structure between the users included in the group; and a network server for managing information about classification of the users according to interests of the users, in which the user information management unit may receive the information about associative relationship between the users from the directory server and the network server.

The Wiki information input unit may include: a WYSIWYG (What you See Is What You Get) based editor for receiving the command for writing or changing the Wiki information from the user; and a viewer for imaging and showing the Wiki information to the user, and the viewer may show, to the user, the Wiki information provided from the Wiki server.

Another exemplary embodiment of the present invention provides a Wiki-based information provision method including: a Wiki information input unit receiving, from a first user, a keyword for retrieving Wiki information defining a web page written and shared by users included in a group consisting of a plurality of users; an access authority management unit checking whether the first user has an access authority for sharing the Wiki information; and a search unit filtering and providing the Wiki information using information about associative relationship between the users according to classes or interests of the users if the first user has the access authority.

The Wiki-based information provision method may further include the search unit retrieving the Wiki information according to the keyword input by the first user before filtering and providing of the Wiki information, in which the retrieved Wiki information may be filtered and provided.

The filtering and providing of the Wiki information may include filtering the Wiki information using an associative relationship expanded on the basis of a first relationship defining a class associative relationship between the users included in the group and a second relationship defining an interest associative relationship between the users.

The filtering and providing of the Wiki information may include: a first filtering step of the search unit filtering the Wiki information retrieved in the retrieval step using the first relationship; and a second filtering step of the search unit filtering the Wiki information filtered in the first filtering step using the second relationship.

The filtering and providing of the Wiki information may include first providing the user with the Wiki information written by the user corresponding to the expanded associative relationship.

The filtering and providing of the Wiki information may include providing the Wiki information retrieved using the keyword input by the first user if the first user has no first or second associative relationship.

Yet another exemplary embodiment of the present invention provides a computer readable recording medium for performing on a computer a Wiki-based information provision method including: receiving, from a first user, a keyword for searching for Wiki information defining a web page written and shared by users included in a group consisting of a plurality of users; checking whether the first user has an access authority for sharing the Wiki information; retrieving the Wiki information according to the keyword input by the first user if the first user has the access authority; and filtering and providing the Wiki information retrieved in the retrieval step using information about associative relationship between the users according to classes or interests of the users.

According to exemplary embodiments of the present invention, it is possible to provide efficient knowledge collaboration means for effectively determining a group intention of members and enhancing work efficiency in an enterprise by creating a group document through a Wiki, reviewing and modifying the created document through the participation of the members, and adding opinions of the members as comments to complete the document. It is also possible to filter a retrieval result using associative relationship between users and first provide information written by a user of the same group as the retrieval result, thus establishing an efficient knowledge collaboration structure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a Wiki-based information provision system according to an exemplary embodiment of the present invention.

FIG. 2 is a block diagram illustrating a detailed configuration of a Wiki server according to an exemplary embodiment of the present invention.

FIG. 3 is a block diagram illustrating a Wiki information management unit 220 according to an exemplary embodiment of the present invention.

FIG. 4 is a flow chart illustrating a Wiki-based information provision method according to an exemplary embodiment of the present invention.

FIG. 5 is a flow chart illustrating a Wiki information filtering step according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

The present invention relates to a method of retrieving and providing information using a Wiki. The Wiki denotes a set of webpages where users may write common documents using a simple markup language in a web browser and add the content. The Wiki has a form where opinions are exchanged sporadically over a network, which denotes a complex system for providing an Internet forum, discussion place, repository, mail system, group work place, and the like, where anyone can modify the content thereof.

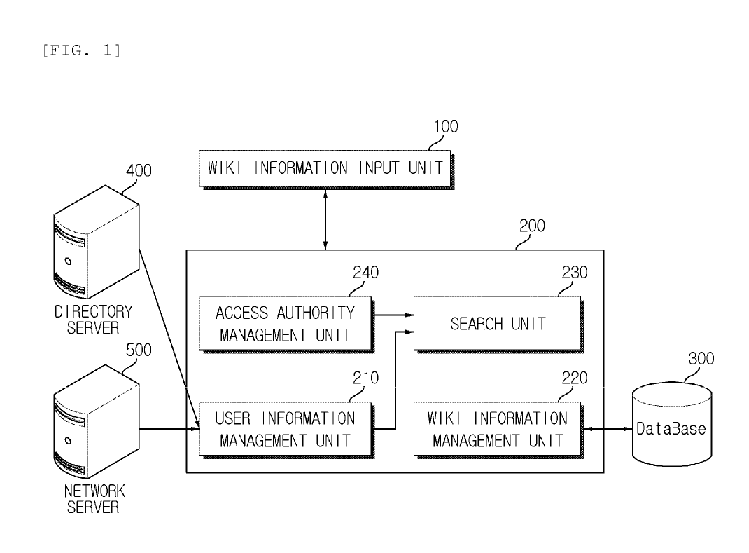

FIG. 1 is a block diagram illustrating a Wiki-based information provision system according to an exemplary embodiment of the present invention.

Referring to FIG. 1, the Wiki-based information provision system according to the exemplary embodiment includes a Wiki information input unit 100, a Wiki server 200, a database 300, a directory server 400, and a network server 500.

The Wiki information input unit 100 receives, from a user included in a group consisting of a plurality of users, a command for writing or changing Wiki information defining a webpage which is written and shared by the user.

The group consisting of the plurality of users denotes a set of users using a specific Wiki, and the group in the exemplary embodiment may be a set of persons writing, retrieving, and modifying a document through an enterprise Wiki.

The Wiki information denotes a webpage which is written and shared by the users included in the group consisting of the plurality of users.

The command for writing or changing Wiki information is an operation in which a Wiki user intends to write or change the Wiki information which is shared through the Wiki system, and may include extraction, retrieval, storage, modification, and any other edition operations of the Wiki information. In the exemplary embodiment, the commands for writing or changing may be a retrieval command for reading or modifying the Wiki information.

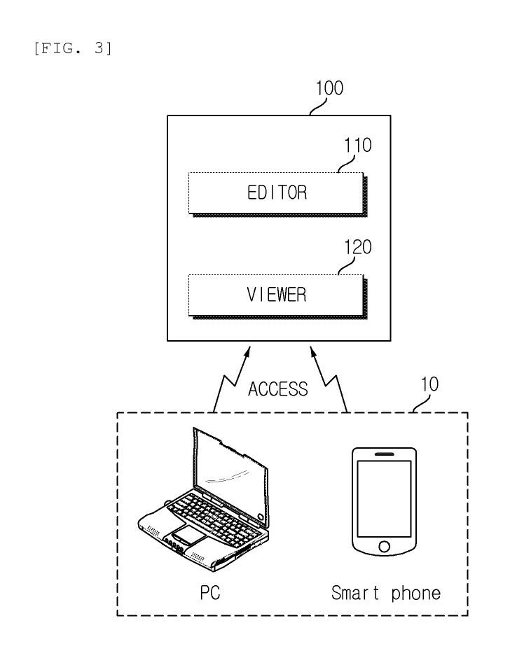

A Wiki information input unit 100 will be described in detail with reference to FIG. 3. FIG. 3 is a block diagram illustrating a detailed configuration of a Wiki server according to an exemplary embodiment of the present invention. Referring to FIG. 3, the Wiki information input unit 100 according to the exemplary embodiment includes an editor 110, a viewer 120, and a terminal device 10. The Wiki information input unit 100 according to the exemplary embodiment may be provided as an application on the Web accessed by the terminal device 10 of a user. The application is software executed on hardware for user's convenience and the application in the exemplary embodiment may include all application programs driven on the Web.

The editor 110 supports a markup language for writing the Wiki information and receives the command for the Wiki information from the user in a WYSIWYG (What You See Is What You Get) manner. The markup language includes Extensible Hypertext Markup Language (XHTML) and HyperText Markup Language (HTML) as a language indicating information about an information structure, and Wireless Markup Language (WML).

The WYSIWYG manner is a system in which a form of a document processed by a program is output as being displayed on an image display device, and denotes a manner in which the user may obtain the same output result as content displayed on a current screen. The editor according to the exemplary embodiment recognizes a structure of each data included in the Wiki information through the markup language, and the user can change the Wiki information as the user visually recognize the Wiki information in the WYSIWYG manner.

The viewer 120 visually output the Wiki information to the user through a display unit of a terminal (for example, PC and smart phone) of a user connected to the Wiki information input unit. The viewer according to the exemplary embodiment may show the user the Wiki information provided by the Wiki server.

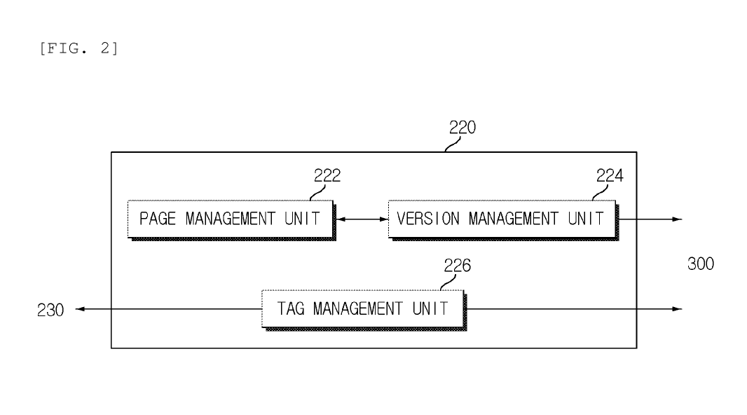

The Wiki server 200 manages the Wiki information input by the user, using information about associative relationships between the users according to classes or interests of the users. The Wiki server 200 will be described in detail with reference to FIG. 2. FIG. 2 is a block diagram illustrating a detailed configuration of a Wiki server according to an exemplary embodiment of the present invention.

The Wiki server 200 according to the exemplary embodiment includes a user information management unit 210, a Wiki information management 220, a search unit 230, and an access authority management unit 240.

The user information management unit 210 manages information about an associative relationship between the users using the Wiki information. The associative relationship between the users includes a first relationship defining a class associative relationship of the users included in a group and a second relationship defining an interest associative relationship of the users. When a group of the users using the Wiki information is an enterprise, the first relationship according to the exemplary embodiment denotes an organization relationship according to the classes of the users in the enterprise. The second relationship may denote a relationship between users who share a common interest of the users through a community related to non-work or work in the enterprise other than the organization relationship. The community may be a social relationship including a club or society in the enterprise.

The user information management unit 210 may manage an expanded associative relationship on the basis of the first and second relationships. The expanded associative relationship may be obtained by classifying the second relationship according to the first relationship. The expanded associative relationship in the exemplary embodiment may be a relationship between users sharing the same community according to the second relationship from among the users having the same class according to the first relationship.

The user information management unit 210 may manage user information in linkage with a directory server 400 for managing information about a class structure of the users included in a group and a network server 500 for managing information about classification of the users according to the interests of the users. The directory server 500 according to the exemplary embodiment manages information about an organization chart of the enterprise and identities of the users, and the network server 600 manages information about a community of the enterprise. The user information management unit 210 extracts the first relationship of the users through the directory server 500 and the second relationship through the network server 600 to acquire the expanded associative relationship.

The Wiki information management unit 220 manages the Wiki information. The Wiki information management unit 220 will be described in detail with reference to FIG. 3. FIG. 3 is a block diagram illustrating a Wiki information management unit 220 according to an exemplary embodiment of the present invention. The Wiki information management unit 220 according to the exemplary embodiment includes a page management unit 222, a version management unit 224, and a tag management unit 226.

The page management unit 222 manages the change in pages forming the Wiki information. Each page is a basic unit of the Wiki information. The change of the page includes check, addition, modification, and deletion of the page. The version management unit 224 manages a version defining information about the change in pages. The user may check whether the Wiki information is updated through the version of the version management unit. The tag management unit 226 manages a tag corresponding to a keyword signifying characteristics of the page. The keyword may be a word defining characteristics of information included in the page. The search unit may extract the Wiki information retrieved by the user through the tag which is managed by the tag management unit 226. The page management unit 222, the version management unit 224, and the tag management unit 226 according to the exemplary embodiment manage the Wiki information in linkage with the database 300.

The database 300 stores and manages the Wiki information written by the user. The database 300 according to the exemplary embodiment may store the Wiki information in a database form using a structured query language (SQL) for accessing data files or database. The data file may have a form where the Wiki information written by the user is stored as a file on the Wiki information. The database form using SQL is designed for data retrieval and management, database schema creation and modification, and database object access control management, and may be in a structure managed through SQL defining a standard language form for acquiring information from the database or updating the information.

The search unit 230 retrieves the Wiki information managed by the Wiki information management unit 220, filters the retrieved Wiki information using information about an associative relationship between the users, and provides the filtered Wiki information. The search unit 230 according to the exemplary embodiment may retrieve the Wiki information using the tag of the page tag management unit 226 and filter the retrieved Wiki information using the expanded associative relationship. In retrieving the Wiki information using the tag, the page tag management unit 226 may extract a page including a corresponding tag, using the keyword input by the user.

In filtering the retrieved Wiki information using information about associative relationship between the users, the expanded associative relationship, the retrieved Wiki information may be filtered using the expanded associative relationship on the basis of the first and second relationships managed by the user information management unit 210. The filtering according to the exemplary embodiment may classify the retrieved information through the first and second relationships. The Wiki information written by the users having the same class may be extracted from the retrieved Wiki information according to the first relationship. The Wiki information written by the users sharing the same community may be extracted from the retrieved Wiki information according to the second relationship. In providing the filtered Wiki information, the Wiki information written by the user corresponding to the expanded associative relationship may be firstly provided to the user. The firstly providing may be what shows a result of raising a search ranking of the Wiki information written by the users according to the first and second relationships when the retrieval result is provided to the user.

The access authority management unit 240 controls access authorities of the users for sharing the Wiki information. When the user accesses the Wiki information, the access authority management unit according to the exemplary embodiment may check whether the user is a member of a group having an authority for sharing the Wiki information to confirm an access authority of the user. If the user has the access authority, the user can change the Wiki information, that is, create and modify the Wiki information. If the user does not have the access authority, the user is notified that the user does not have the access authority.

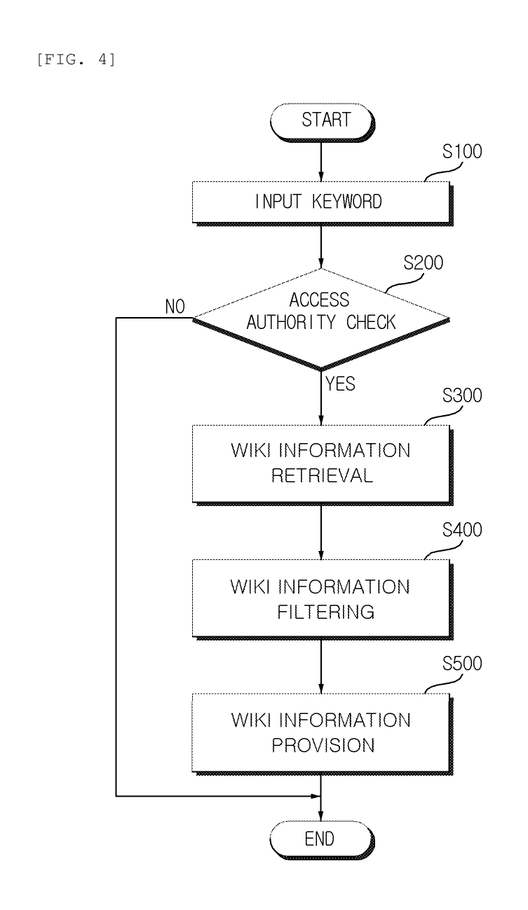

FIG. 4 is a flow chart illustrating a Wiki-based information provision method according to an exemplary embodiment of the present invention. Referring to FIG. 4, the Wiki-based information provision method, which is performed in the Wiki-based information provision system according to the exemplary embodiment, includes a keyword input step S100, an access authority check step S200, a Wiki information retrieval step S300, a Wiki information filtering step S400, and a Wiki information provision step S500.

In the keyword input step S100, the Wiki information input unit 100 receives, from a first user, a keyword for retrieving Wiki information defining a web page which is written and shared by users included in a group consisting of a plurality of users. In the exemplary embodiment, the first user is a user who intends to access the Wiki information. To obtain desired Wiki information, the first user inputs a keyword through the Wiki information input unit 100 to command the retrieval of the Wiki information.

In the access authority check step S200, the access authority management unit 240 checks whether the first user has an access authority for sharing the Wiki information. As described above, when the user accesses the Wiki information, the access authority management unit according to the exemplary embodiment may check whether the user is a member of a group having an authority for sharing the Wiki information to confirm an access authority of the user. If the user has the access authority, the user can change the Wiki information, that is, create and modify the Wiki information. If the user does not have the access authority, the user is notified that the user does not have the access authority.

In the Wiki information retrieval step S300, the search unit 230 retrieves Wiki information managed by the Wiki information management unit 220. In the Wiki information retrieval step S300 according to the exemplary embodiment, the search unit 230 may retrieve the Wiki information using the tag of the tag management unit 226. In retrieving the Wiki information using the tag, the tag management unit 226 may extract a page including a corresponding tag, using the keyword input by the user.

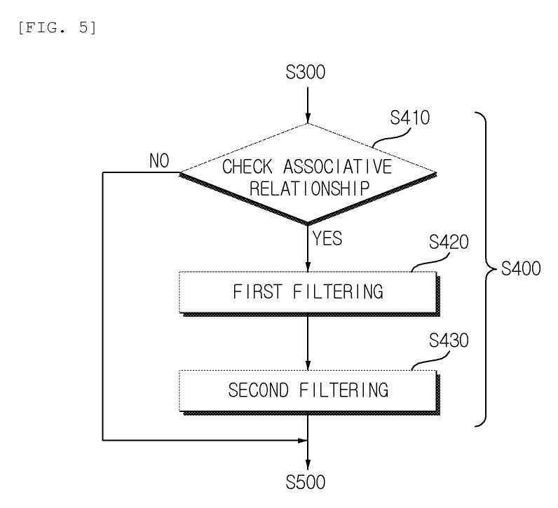

In the Wiki information filtering step S400, the search unit 300 filters the Wiki information retrieved in the Wiki information retrieval step S300 using an associative relationship expanded on the basis of the first relationship defining a class associative relationship between users included in the same group and the second relationship defining an interest associative relationship between the users. This will be described in detail with reference to FIG. 5. FIG. 5 is a detailed flow chart illustrating the Wiki information filtering step according to an exemplary embodiment of the present invention.

Referring to FIG. 5, the Wiki information filtering step S400 according to the exemplary embodiment includes an associative relationship check step S410, a first filtering step S420, and a second filtering step S430.

In the associative relationship check step S410, associative relationship information of a user who inputs a keyword for retrieval in the keyword input step S100 is checked. If there is the associative relationship information regarding the user in the exemplary embodiment, the Wiki information is filtered using this information. If there is no associative relationship, the retrieved information is provided without filtering (S500).

In the first filtering step S420, the Wiki information retrieved in the retrieval step S300 is filtered using the first relationship. In the exemplary embodiment, the first filtering may be extracting the Wiki information written by the users of the same class as a user who inputs a keyword for retrieval according to the first relationship.

In the second filtering step S430, the information filtered in the first filtering step S420 is filleted using the second relationship. In the exemplary embodiment, the second filtering may be extracting Wiki information written by the users sharing the same community according to the second relationship from the Wiki information extracted according to the first relationship.

In the Wiki information provision step S500, the Wiki information filtered in the Wiki information filtering step S400 through the search unit 230 is provided. In the Wiki information provision step S500 according to the exemplary embodiment, the Wiki information written by the user corresponding to the expanded associative relationship may be firstly provided to the user. As described above, the firstly providing may be what shows a result of raising the search ranking of the Wiki information written by the users according to the first and second relationships when the retrieval result is provided to the user.

In the Wiki information provision step S500, the Wiki information retrieved using the keyword input by the first user may be provided if the first user does not have the first or second associative relationship. The Wiki information provided in the Wiki information provision step S500 according to the exemplary embodiment includes the information retrieved in the Wiki information retrieval step S300, the information filtered through the first filtering step S420, and the information filtered through the first and second filtering step S420 and S430. The Wiki information provision step S500 includes visualizing the Wiki information provided by the search unit 300 through the Wiki information input unit 100 and then displaying the visualized Wiki information to the user.

The method of providing Wiki-based information according to an exemplary embodiment of the present invention can be implemented as computer readable codes on a computer readable recording medium. The computer readable recording medium includes any data storage devices that can store data which can be thereafter read by a computer system.

The embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A Wiki-based information provision system comprising:
a Wiki information input unit for receiving, from a user, a command for writing or changing Wiki information defining a web page written and shared by users included in a group consisting of a plurality of users; and
a Wiki server for managing the Wiki information input by the user by using information about associative relationship between the users according to classes or interests of the users.

2. The Wiki-based information provision system of claim 1, wherein the Wiki server comprises:
a user information management unit for managing the information about associative relationship between the users;
a Wiki information management unit for managing the Wiki information; and
a search unit for retrieving the Wiki information managed by the Wiki information management unit, filtering the retrieved information with the information about associative relationship between the users, and providing the filtered information.

3. The Wiki-based information provision system of claim 2, further comprising:
an authority management unit for controlling access authorities of the users for sharing the Wiki information.

4. The Wiki-based information provision system of claim 2, wherein the Wiki information management unit comprises:
a page management unit for managing change in pages forming the Wiki information;
a version management unit for managing a version defining information about the change in pages; and
a page tag management unit for managing a tag corresponding to a keyword signifying characteristics of each page.

5. The Wiki-based information provision system of claim 4, wherein the user information management unit manages associative relationship expanded on the basis of a first relationship defining a class associative relationship between the users included in the group and a second relationship defining an interest associative relationship between the users.

6. The Wiki-based information provision system of claim 5, wherein the search unit retrieves for the Wiki information using the tag of the page tag management unit and filters the retrieved Wiki information using the expanded associative relationship.

7. The Wiki-based information provision system of claim 6, wherein the search unit first provides the user with the Wiki information written by the user corresponding to the expanded associative relationship when providing the filtered Wiki information.

8. The Wiki-based information provision system of claim 2, further comprising:
a database for storing the Wiki information written by the user,
wherein the Wiki information management unit of the Wiki server manages the Wiki information in linkage with the database.

9. The Wiki-based information provision system of claim 8, wherein the database stores the Wiki information in a data file or database form using a structured query language (SQL) for database access.

10. The Wiki-based information provision system of claim 2, further comprising:
a directory server for managing information about a class structure between the users included in the group; and
a network server for managing information about classification of the users according to interests of the users,
wherein the user information management unit receives the information about associative relationship between the users from the directory server and the network server.

11. The Wiki-based information provision system of claim 1, wherein the Wiki information input unit comprises:
a WYSIWYG (What you See Is What You Get) based editor for receiving the command for writing or changing the Wiki information from the user; and
a viewer for imaging and showing the Wiki information to the user, the viewer showing, to the user, the Wiki information provided from the Wiki server.

12. A Wiki-based information provision method comprising:
a Wiki information input unit receiving, from a first user, a keyword for retrieving for Wiki information defining a web page written and shared by users included in a group consisting of a plurality of users;
an access authority management unit checking whether the first user has an access authority for sharing the Wiki information; and
a search unit filtering and providing the Wiki information using information about associative relationship between the users according to classes or interests of the users if the first user has the access authority.

13. The Wiki-based information provision method of claim 12, further comprising:
the search unit retrieving the Wiki information according to the keyword input by the first user before the filtering and providing of the Wiki information,
wherein the retrieved Wiki information is filtered and provided.

14. The Wiki-based information provision method of claim 13, wherein the filtering and providing of the Wiki information comprises filtering the Wiki information using an associative relationship expanded on the basis of a first relationship defining a class associative relationship between the users included in the group and a second relationship defining an interest associative relationship between the users.

15. The Wiki-based information provision method of claim 14, wherein the filtering and providing of the Wiki information comprises:
a first filtering step of the search unit filtering the Wiki information retrieved in the retrieving step using the first relationship; and
a second filtering step of the search unit filtering the Wiki information filtered in the first filtering step using the second relationship.

16. The Wiki-based information provision method of claim 14, wherein the filtering and providing of the Wiki information comprises first providing the user with the Wiki information written by the user corresponding to the expanded associative relationship.

17. The Wiki-based information provision method of claim 14, wherein the filtering and providing of the Wiki information comprises providing the Wiki information retrieved using the keyword input by the first user if the first user has no first or second associative relationship.
